(19) United States
(12) Patent Application Publication
(10) Pub. No.: US 2025/0229678 A1
(43) Pub. Date: Jul. 17, 2025

(54) VEHICLE SEAT

(71) Applicant: TACHI-S CO., LTD., Tokyo (JP)

(72) Inventors: Motoshi MINEGISHI, Tokyo (JP); Hiroyuki YAJIMA, Tokyo (JP); Daiki TANAKA, Tokyo (JP); Yuhi ISHIHARA, Tokyo (JP)

(73) Assignee: TACHI-S CO., LTD., Tokyo (JP)

(21) Appl. No.: 19/009,487

(22) Filed: Jan. 3, 2025

(30) Foreign Application Priority Data
Jan. 17, 2024 (JP) 2024-005424

(51) Int. Cl. B60N 2/56

(52) U.S. Cl. CPC B60N 2/5642

(57) ABSTRACT

A vehicle seat including: an intake and exhaust unit configured to perform intake and exhaust of air; a blower device; and a bracket supporting the blower device, in which the bracket includes an air flow path therein, the air flow path connecting the blower device and an exhaust port of the intake and exhaust unit.

### CROSS REFERENCE TO RELATED APPLICATIONS

This application is based on and claims priority under 35 USC 119 from Japanese Patent Application 2024-005424 filed on Jan. 17, 2024, the entire content of which is incorporated herein by reference.

### TECHNICAL FIELD

The present disclosure relates to a vehicle seat.

### BACKGROUND ART

JP6395934B describes a vehicle seat including a seat back frame that forms a framework of a seat back, a blower disposed within the seat back, a bracket to which the blower is fixed, and a cover member provided on a rear side of the seat back frame, the bracket pinching the seat back frame between the bracket and the cover member and being fixed to the cover member.

An object of the present disclosure is to reduce a manufacturing cost of a vehicle seat with an air conditioning function.

### SUMMARY OF INVENTION

According to an aspect of the present disclosure, there is provided a vehicle seat, including:
an intake and exhaust unit configured to perform intake and exhaust of air;
a blower device; and
a bracket supporting the blower device, in which
the bracket includes an air flow path therein, the air flow path connecting the blower device and an exhaust port of the intake and exhaust unit.

### BRIEF DESCRIPTION OF DRAWINGS

FIG. 1 is an external perspective view illustrating a schematic configuration of a vehicle seat 1 which is an embodiment of the present disclosure.

FIG. 2 is a schematic diagram illustrating an internal configuration of a seat back 3.

FIG. 3 is an exploded perspective view of a connecting member 62, a blower device 63, and a bracket 64 illustrated in FIG. 2.

FIG. 4 is a perspective view of the blower device 63 and bracket 64 seen from a direction different from that of FIG. 3.

FIG. 5 is a perspective view of the bracket 64 seen from a direction different from that of FIGS. 3 and 4.

FIG. 6 is a view of the bracket 64 seen from rear.

FIG. 7 is a schematic cross-sectional view of the blower device 63, the bracket 64, and an upper frame 33U in a connected state.

### DESCRIPTION OF EMBODIMENTS

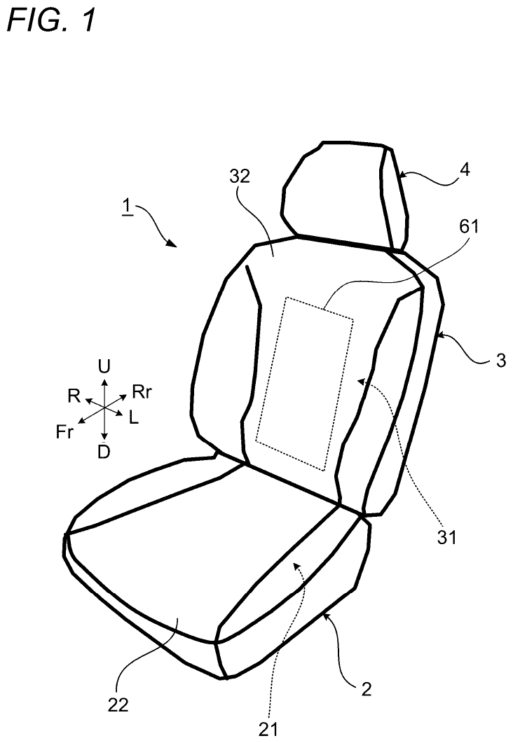

FIG. 1 is an external perspective view illustrating a schematic configuration of a vehicle seat 1 according to an embodiment of the present disclosure. A vehicle in this specification includes an automobile, an airplane, a train, a mobile drone, a ship, and the like. In the following description, the front of an occupant sitting in a normal position on the vehicle seat 1 is referred to as a front direction Fr, and an opposite direction of the front direction Fr is referred to as a rear direction Rr, and these are collectively referred to as a front-rear direction. In addition, a right side of the occupant when viewed from behind is referred to as a right direction R, and a left side of the occupant is referred to as a left direction L, and these are collectively referred to as a left-right direction. In addition, a direction perpendicular to the front-rear direction and the left-right direction, from a headrest toward a seat surface side, is referred to as a down direction D, and an opposite direction of the down direction D is referred to as an up direction U, and these are collectively referred to as an up-down direction. The front-rear direction, the left-right direction, and the up-down direction intersect with each other.

The vehicle seat 1 includes a seat cushion 2 that supports buttocks and thighs of an occupant, a seat back 3 that supports waist and back of the occupant, and a headrest 4 that supports a head of the occupant. In an example of FIG. 1, the vehicle seat 1 is a driver's seat or passenger seat of an automobile, but it may also be a rear bench seat or the like.

The seat cushion 2 has a seat frame (not illustrated) that forms a framework, and this seat frame is covered with a cushion pad 21 made of a relatively soft resin foam material such as urethane foam, and is further covered with a trim cover 22 including a covering material such as leather, woven fabric, or nonwoven fabric.

The seat back 3 has a seat frame (not illustrated) that forms a framework, and this seat frame is covered with a cushion pad 31 made of a relatively soft resin foam material such as urethane foam, and is further covered with a trim cover 32 including a covering material such as leather, woven fabric, or nonwoven fabric. An air conditioning mat 61 for conditioning the interior of the vehicle seat 1 is provided inside the seat back 3.

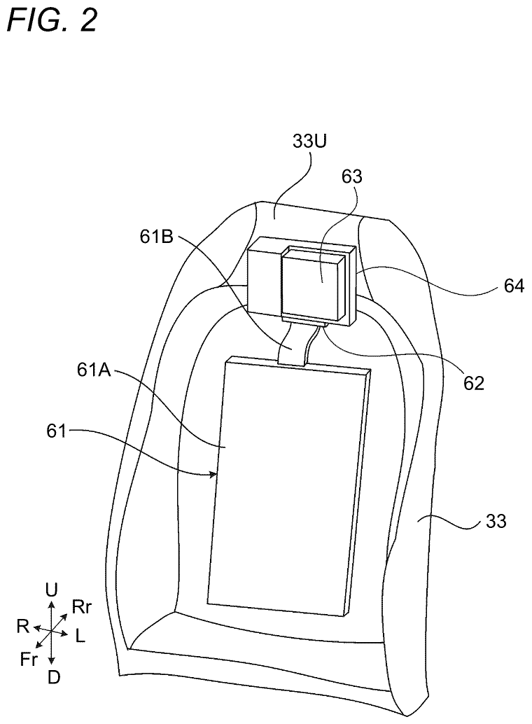

FIG. 2 is a schematic diagram illustrating an internal configuration of the seat back 3. FIG. 2 illustrates the seat back 3 without the cushion pad 31 and the trim cover 32. Inside the seat back 3, there are provided the air conditioning mat 61, a blower device 63, a bracket 64 supporting the blower device 63, a seat frame 33 supporting the bracket 64, and a connecting member 62 connecting the bracket 64 and the air conditioning mat 61. In an example of FIG. 2, the seat frame 33 is frame-shaped and has a pair of side frames arranged on the left and right, a lower frame connecting lower ends of the pair of side frames, and an upper frame 33U connecting upper ends of the pair of side frames. The bracket 64 is supported by the upper frame 33U.

The air conditioning mat 61 is supported by the seat frame 33 by a support member (not illustrated) extending from the seat frame 33. The air conditioning mat 61 may be bonded to the cushion pad 31 by adhesive. The air conditioning mat 61 includes a body portion 61A having a hollow flat rectangular shape and a duct portion 61B having a flat cylindrical shape and extending in the up direction U from an upper end of the body portion 61A. The body portion 61A has a plurality of vents on a front surface thereof that lead to the interior. The duct portion 61B is connected to an internal space of the body portion 61A. The air conditioning mat 61 can take in air from the vents of the body portion 61A into the body portion 61A and discharge the taken-in air from the duct portion 61B. In this way, the air conditioning mat 61 forms an intake and exhaust unit that can take in air from the vents and exhaust air from the duct portion 61B. The duct portion 61B forms an exhaust port of the air conditioning mat 61. A configuration of the intake and exhaust unit is not limited to that illustrated in FIG. 2, and various configurations can be adopted.

The connecting member 62 connects the duct portion 61B (an exhaust port of the air conditioning mat 61) and the bracket 64. The connecting member 62 may be configured integrally with the duct portion 61B, or may be configured integrally with the bracket 64.

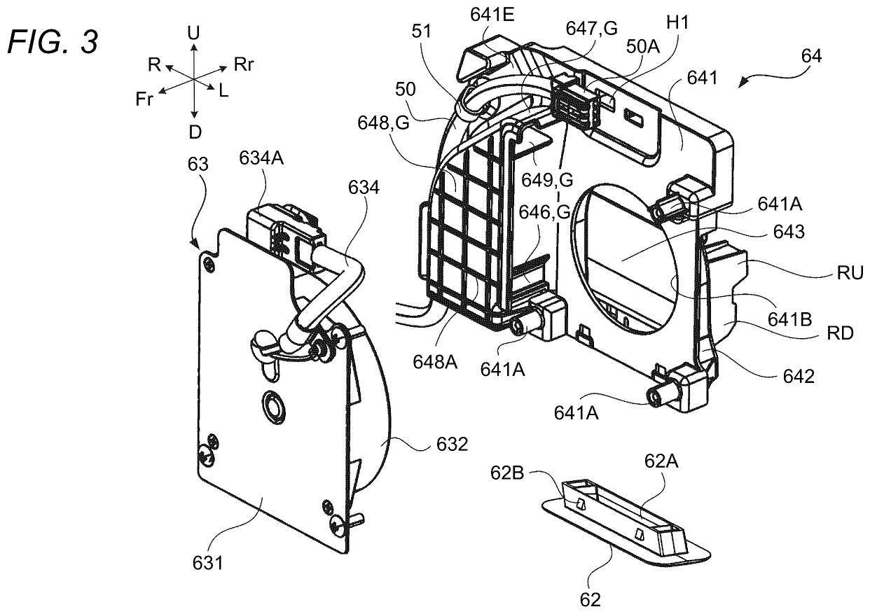

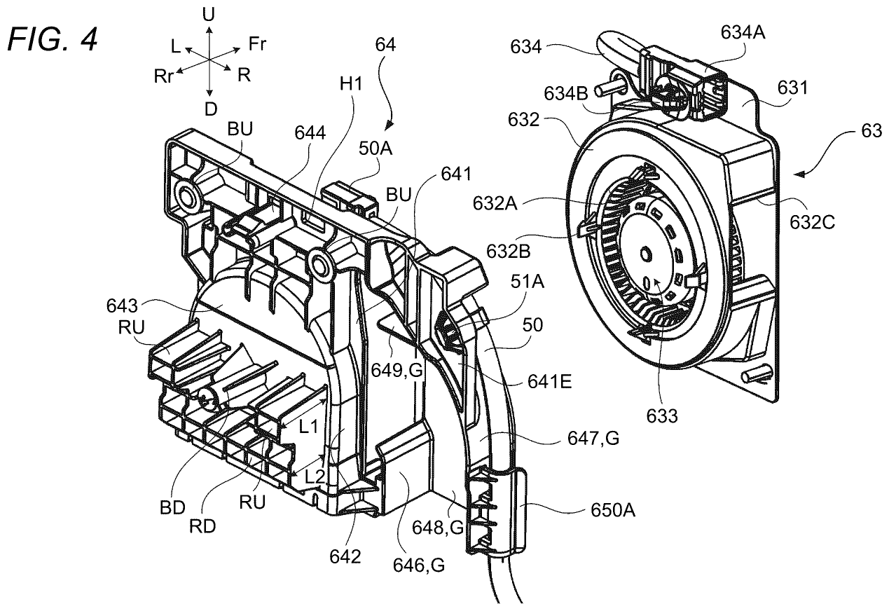

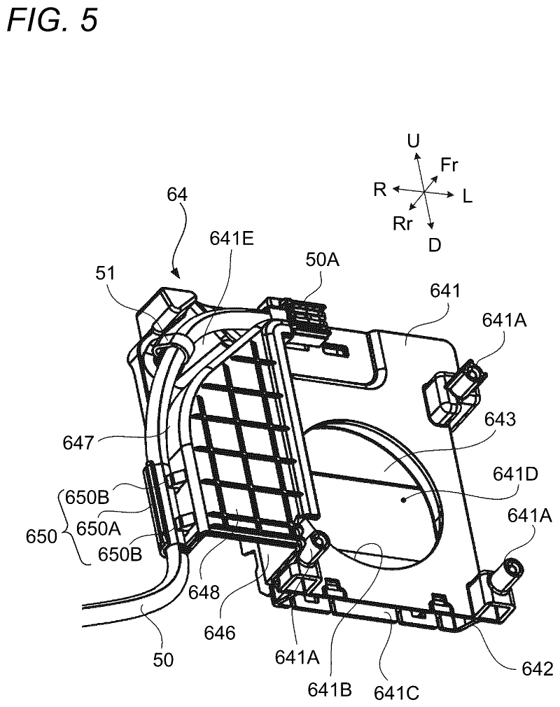

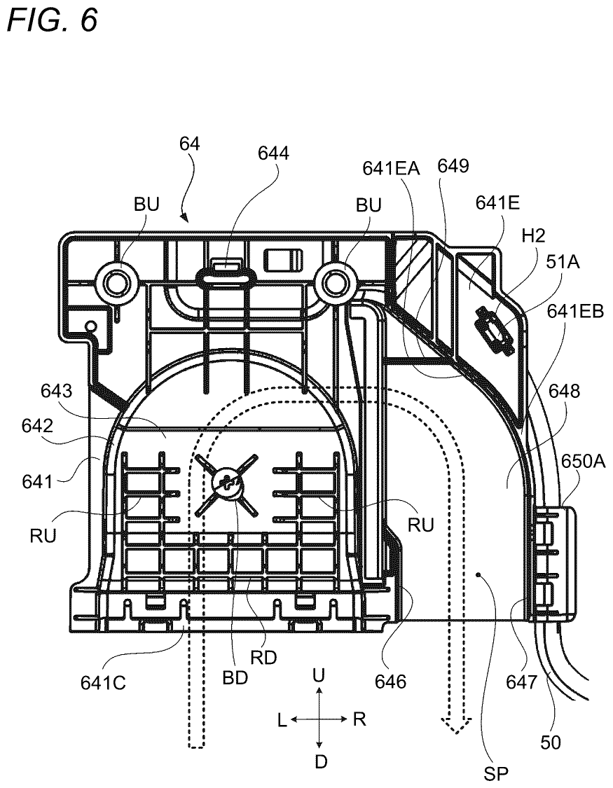

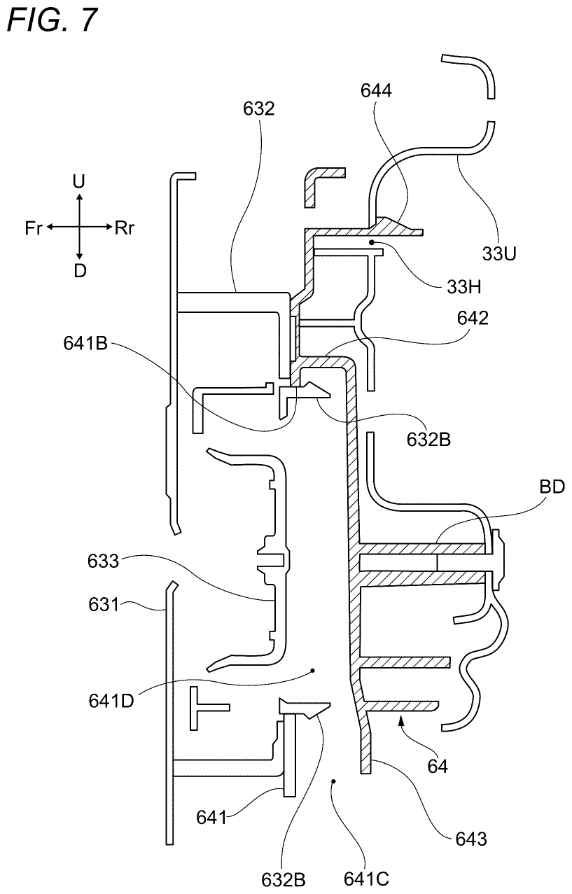

FIG. 3 is an exploded perspective view of the connecting member 62, the blower device 63, and the bracket 64 illustrated in FIG. 2. FIG. 4 is a perspective view of the blower device 63 and the bracket 64 seen from a direction different from that of FIG. 3. FIG. 5 is a perspective view of the bracket 64 seen from a direction different from that of FIGS. 3 and 4. FIG. 6 is a view of the bracket 64 seen from the rear. FIG. 7 is a schematic cross-sectional view of the blower device 63, the bracket 64, and the upper frame 33U in a connected state.

The blower device 63 is a machine that pumps gas by a rotational motion of an impeller or rotor or a reciprocating motion of a piston, and in one example, can be an electric fan device. In examples of FIGS. 3 and 4, the blower device 63 includes a flat plate 631, for example made of metal, of which a thickness direction coincides with the front-rear direction, an accommodating member 632 having a substantially cylindrical shape and fixed to a rear surface of the flat plate 631, a rotor 633 accommodated inside the accommodating member 632 and rotatably supported by the flat plate 631, and a first cable 634 electrically connected to the rotor 633. A female connector 634A is provided at a tip of the first cable 634.

An intake port 632A formed of, for example, a circular opening is formed on a rear surface of the accommodating member 632. This surface has four engagement claws 632B protruding in the rear direction Rr around the intake port 632A in the example illustrated. An exhaust port 632C formed of, for example, a rectangular opening is formed on a right side surface of the accommodating member 632. When the blower device 63 is operated, the rotor 633 rotates and air is sucked in through the intake port 632A, and the air is discharged from the exhaust port 632C.

The bracket 64 has a structure in which an air flow path 641D (see FIGS. 5 and 7) that connects the blower device 63 and the exhaust port (duct portion 61B) of the air conditioning mat 61 is provided inside the bracket 64. The bracket 64 has a planar portion 641 having a flat plate shape of which a thickness direction is approximately parallel to the front-rear direction, a U-shaped wall portion 642 that is erected in the rear direction Rr from a rear surface of the planar portion 641 and is formed in an approximately U-shape when viewed in the front-rear direction, and a rear surface portion 643 having a flat plate shape that connects rear end edges of the U-shaped wall portion 642. A space partitioned by the planar portion 641, the U-shaped wall portion 642, and the rear surface portion 643 forms the air flow path 641D. The planar portion 641, the U-shaped wall portion 642, and the rear surface portion 643 are flow path forming portions that form the air flow path 641D.

The planar portion 641 has a first opening 641B, which is, for example, circular and which leads to the air flow path 641D. The U-shaped wall portion 642 extends from a lower-right end of the planar portion 641 to a lower-left end of the planar portion 641 when viewed in the rear direction Rr. As illustrated in FIG. 5, a lower end edge of the U-shaped wall portion 642, a lower end edge of the planar portion 641, and a lower end edge of the rear surface portion 643 form a second opening 641C which leads to the air flow path 641D. The second opening 641C has a shape corresponding to the connecting member 62, and the connecting member 62 connected to the duct portion 61B is inserted into the second opening 641C and engages with the second opening 641C. As illustrated in FIG. 3, the connecting member 62 has a long and narrow rectangular tube shape with a brim, and engagement claws 62B are provided on side surfaces in the front-rear direction. A tip of the duct portion 61B is inserted into and fixed to a hollow portion 62A of the connecting member 62. The engagement claws 62B respectively engage with engagement recesses (not illustrated) provided on lower ends of the planar portion 641 and the rear surface portion 643 of the bracket 64.

The first opening 641B of the planar portion 641 engages with the four engagement claws 632B of the blower device 63 illustrated in FIG. 4. This engagement connects the intake port 632A of the blower device 63 to the air flow path 641D. As described above, the second opening 641C connects with the duct portion 61B by engaging the connecting member 62 therewith. Thus, the bracket 64 has the first opening 641B connected to the intake port 632A of the blower device 63 and the second opening 641C connected to the duct portion 61B of the air conditioning mat 61. The first opening 641B and the second opening 641C face in different directions (perpendicular to the opening surface). In the example illustrated in the figure, the first opening 641B faces the front direction Fr, and the second opening 641C faces the down direction D.

Three bosses 641A are erected in the front direction Fr on a periphery edge of a front surface of the planar portion 641. Screw holes are provided in the flat plate 631 of the blower device 63 at positions corresponding to the bosses 641A, and the blower device 63 is fixed to the bracket 64 by screws inserted into the screw holes and fixed to the bosses 641A.

As illustrated in FIG. 4, a lower boss BD for fixing to the upper frame 33U is erected in the rear direction Rr on the rear surface portion 643 of the bracket 64. Furthermore, on the rear surface portion 643 of the bracket 64, a pair of reinforcing upper ribs RU arranged on the left and right sides of the lower boss BD, and reinforcing lower ribs RD provided below the upper rib RU and the lower boss BD are erected in the rear direction Rr. As illustrated in FIG. 4, a height L1 of the upper rib RU in the front-rear direction and a height L2 of the lower rib RD in the front-rear direction are different, and the height L1 is greater than the height L2. It is preferable that the height of the lower boss BD in the front-rear direction is the same as the height L1 of the upper rib RU.

As illustrated in FIG. 4, an engagement claw 644 is provided on the rear surface of the planar portion 641 above the U-shaped wall portion 642 and approximately in a center in the left-right direction, and the engagement claw 644 is erected in the rear direction Rr, being able to engage with the upper frame 33U. Also, on the rear surface of the planar portion 641, upper bosses BUs for fixing to the upper frame 33U are provided to the right and left of the engagement claw 644. Through holes are provided in the upper frame 33U at positions corresponding to the lower boss BD and two upper bosses BUs in the bracket 64. By inserting screws into the through holes and connecting the screws to the lower boss BD and two upper bosses BUs, the bracket 64 is fixed to the upper frame 33U and the bracket 64 is supported by the upper frame 33U.

As illustrated in FIG. 7, the upper frame 33U has an engagement hole 33H at a position corresponding to the engagement claw 644. When fixing the bracket 64 to the upper frame 33U, the engagement claw 644 is first engaged with the engagement hole 33H, thereby positioning (temporarily fixing) the bracket 64 to the upper frame 33U. In this state, the upper bosses BU and the lower boss BD are each positioned to face the through holes provided in the upper frame 33U. This allows the bracket 64 to be efficiently assembled to the seat frame 33.

As illustrated in FIG. 3, the bracket 64 has a protruding portion 641E that protrudes from a right end of an upper end part of the planar portion 641 in the right direction R and down direction D. A front surface of the protruding portion 641E and a front surface of the planar portion 641 are positioned approximately the same in the front-rear direction. In the bracket 64, a guide portion G is provided between the protruding portion 641E and the planar portion 641 to guide flow of air discharged from the exhaust port 632C of the blower device 63 fixed to the bracket 64.

The guide portion G is configured to direct air discharged in the right direction R from the exhaust port 632C of the blower device 63 in the down direction D. As illustrated in FIG. 6, the guide portion G includes a right guide wall portion 647 extending in a lower right direction from the upper-right end of the planar portion 641 along the protruding portion 641E, a left guide wall portion 646 extending in the down direction adjacent to the lower-right end of the planar portion 641, a front wall portion 648 connecting front end edges of the left guide wall portion 646 and right guide wall portion 647, and a flow path adjustment portion 649.

The right guide wall portion 647 stands in the front direction Fr from an end edge 641EA on a lower side of the protruding portion 641E. The right guide wall portion 647 extends to a position beyond a tip 641EB of the protruding portion 641E, and after passing the tip 641EB, the right guide wall portion 647 extends in the down direction D.

As illustrated in FIG. 4, the left guide wall portion 646 stands in the front direction Fr from a right end edge of a lower end part of the planar portion 641. The front end edges of the left guide wall portion 646 and the right guide wall portion 647 are connected by the front wall portion 648 having a plate-shape that is approximately perpendicular to the front-rear direction. As illustrated in FIG. 3, it is preferable that a reinforcing rib 648A having a lattice shape is provided on a front surface of the front wall portion 648. The flow path adjustment portion 649 having a flat plate shape that is perpendicular to the up-down direction stands in the rear direction Rr on a rear surface of the front wall portion 648 near an upper end.

As illustrated in FIG. 6, a space SP having a curved shape and extending in a lower right direction is defined by the left guide wall portion 646, the right guide wall portion 647, the front wall portion 648, and the flow path adjustment portion 649. When the bracket 64 is fixed to the upper frame 33U, the upper frame 33U is disposed facing the front wall portion 648. Therefore, the space SP is substantially closed by the upper frame 33U as the left guide wall portion 646, the right guide wall portion 647, and the flow path adjustment portion 649 abut against the upper frame 33U.

The space SP faces the exhaust port 632C of the blower device 63. When viewed in the left-right direction, the exhaust port 632C is positioned between the flow path adjustment portion 649 and the left guide wall portion 646. Therefore, air discharged from the exhaust port 632C flows into the space SP from between the flow path adjustment portion 649 and the left guide wall portion 646. The air that flows into the space SP flows along this space SP and is ultimately discharged from the space SP in the down direction D.

In FIG. 6, a flow path of the air flowing in from the second opening 641C of the bracket 64 is schematically illustrated by a dashed arrow. The air flowing in from the second opening 641C passes through the air flow path 641D and reaches the intake port 632A of the blower device 63 from the first opening 641B. The air is then discharged from the exhaust port 632C of the blower device 63, moves to the space SP, flows in a lower right direction, and is discharged in the down direction D.

In the above description, the space SP is closed by the upper frame 33U, but even when the space SP is not closed by the upper frame 33U, the guide portion G can guide the flow of air discharged from the blower device 63 so that the air flows in the down direction D. In this embodiment, a substantially C-shaped opening formed by a lower end edge of the left guide wall portion 646, a lower end edge of the front wall portion 648, and a lower end edge of the right guide wall portion 647 forms an outlet (an outlet of the air guided by the guide portion G) of the guide portion G. This guide portion G is not essential, but by providing the guide portion G, the flow of air can be controlled, making it easier to suppress noise during exhaust.

When a part of the bracket 64 excluding the guide portion G is defined as a first part, the guide portion G has a second part (front wall portion 648) located further forward in the front direction Fr than the first part, and a third part (left guide wall portion 646 and right guide wall portion 647) connecting the first part and the second part (front wall portion 648). By providing the guide portion G, the front wall portion 648 can receive a load from the front direction Fr, so that strength of the bracket 64 can be increased. In addition, when the blower device 63 is fixed to the bracket 64, it is preferable that the flat plate 631 of the blower device 63 and the front wall portion 648 of the bracket 64 are configured to be positioned at approximately the same position in the front-rear direction. In this way, the front wall portion 648 and the blower device 63 can receive a load from the front direction Fr over a wide surface, and this load can be efficiently released to the seat frame 33.

As illustrated in FIG. 3, the vehicle seat 1 is provided with a second cable 50 that connects the first cable 634 of the blower device 63 to vehicle's electrical wiring. A base end of the second cable 50 passes through the inside of the vehicle seat 1 and is connected to, for example, a control device built into a body of the vehicle. A male connector 50A is provided at a tip of the second cable 50, and by connecting the male connector 50A to the female connector 634A of the first cable 634, the blower device 63 can be driven by the control device or the like.

As illustrated in FIG. 4, the bracket 64 has an engagement hole H1 penetrating in the front-rear direction at an upper end of the planar portion 641 facing the blower device 63. The female connector 634A of the first cable 634 has an engagement protrusion 634B that engages with the engagement hole H1. The first cable 634 is supported by the bracket 64 as the engagement protrusion 634B engages with the engagement hole H1. The engagement hole H1 provided in the bracket 64 forms a first support portion that supports the first cable 634. The engagement hole H1 may be replaced with an engagement protrusion, and the engagement protrusion 634B may be configured as an engagement hole that engages with the engagement protrusion. The engagement hole does not need to be a through hole and may be a recess or the like.

As illustrated in FIG. 6, the protruding portion 641E of the bracket 64 has an engagement hole H2 penetrating in the front-rear direction. A clip 51 (see FIG. 5) having a C shape is attached to the second cable 50, and an engagement protrusion 51A integrated with the clip 51 engages with the engagement hole H2, thereby supporting the second cable 50 on the bracket 64. The engagement hole H2 provided in the bracket 64 forms a second support portion that supports the second cable 50. The engagement hole H2 may be replaced with an engagement protrusion, and the engagement protrusion 51A may be configured as an engagement hole that engages with the engagement protrusion. The engagement hole does not need to be a through hole, and may be a recess or the like.

As illustrated in FIG. 5, the second cable 50 supported by the protruding portion 641E of the bracket 64 is arranged along the right guide wall portion 647. A protruding height (length in the front-rear direction) of the right guide wall portion 647 from the protruding portion 641E is preferably smaller than an outer diameter of the second cable 50. In this way, the second cable 50 can be arranged behind the front wall portion 648, and the second cable 50 can be protected against an impact to the bracket 64 from the front.

As illustrated in FIGS. 4 and 5, a cable locking portion 650 that locks the second cable 50 is provided at a lower end of the right guide wall portion 647. The cable locking portion 650 includes a locking plate 650A with a C-shaped cross section that extends forward from a rear end edge of the right guide wall portion 647, and two locking claws 650B that are spaced apart in the up-down direction on a front end edge of the right guide wall portion 647. The second cable 50 is locked to the bracket 64 by pinching a part of the second cable 50 further on a base end side than a part supported by the bracket 64 in the clip 51 between the locking plate 650A and the locking claws 650B.

By providing the cable locking portion 650 on the bracket 64, the position of the second cable 50 can be stabilized. The locking plate 650A is configured to cover a rear side of the second cable 50, and is located between the upper frame 33U and the second cable 50. As a result, the locking plate 650A can protect the second cable 50 against a load from the upper frame 33U. In addition, the protruding portion 641E is provided between a part of the second cable 50 above the cable locking portion 650 and the upper frame 33U. As a result, the second cable 50 can be protected by the protruding portion 641E.

The vehicle seat 1 configured as above is assembled, for example, as follows. First, the upper frame 33U and the bracket 64 are fixed with screws. Next, the blower device 63 is fixed to the bracket 64 with screws. In this case, the engagement hole H1 of the bracket 64 is engaged with the engagement protrusion 634B of the first cable 634 of the blower device 63. Next, the clip 51 is attached to the second cable 50, and the male connector 50A is connected to the female connector 634A. Next, the engagement protrusion 51A is engaged with the engagement hole H2, and the second cable 50 is locked to the cable locking portion 650. Finally, the second opening 641C of the bracket 64 is connected to the connecting member 62.

According to this embodiment, the bracket 64 has the air flow path 641D and also functions as a support member for the second cable 50. As a result, compared to the configuration of the related art, it is possible to reduce the number of parts and the size of bracket 64, thereby enabling reduced manufacturing costs, size, and weight.

In the above description, an example is shown in which the air conditioning mat 61, the connecting member 62, the blower device 63, the bracket 64, and the second cable 50 are provided inside the seat back 3, but the air conditioning mat 61, the connecting member 62, the blower device 63, the bracket 64, and the second cable 50 may be provided inside the seat cushion 2, or may be provided inside both the seat cushion 2 and the seat back 3.

As described above, this specification discloses the following items. The elements in parentheses correspond to the components in the above-described embodiment, but are not limited to these.

(1) A vehicle seat, including:
an intake and exhaust unit (air conditioning mat 61) for performing intake and exhaust of air;
a blower device (blower device 63); and
a bracket (bracket 64) supporting the blower device, where
an air flow path (air flow path 641D) that connects the blower device and an exhaust port (duct portion 61B) of the intake and exhaust unit is provided in the bracket.

According to (1), air can be made to flow from the intake and exhaust unit to the blower device by using the bracket required to support the blower device, simplifying the structure from the intake and exhaust unit to the blower device. For example, compared to a configuration in which a member that forms an air flow path from the intake and exhaust unit to the blower device is provided separately from the bracket and the member is supported by the bracket, the elimination of the member makes it possible to make the bracket smaller, contributing to making the vehicle seat lighter, smaller, and less expensive.

(2) The vehicle seat according to (1), where
the bracket has a first opening (first opening 641B) connected to an intake port (intake port 632A) of the blower device and a second opening (second opening 641C) connected to the exhaust port (duct portion 61B) of the intake and exhaust unit, and
the first opening and the second opening face in different directions.

According to (2), a direction of the air discharged from the intake and exhaust unit can be changed by using the bracket, simplifying the structure from the intake and exhaust unit to the blower device. This can also be easily achieved even when the bracket is fixed to the seat frame, for example.

(3) The vehicle seat according to (2), where
the first opening faces a front of the vehicle seat, and
the second opening faces downward of the vehicle seat.

According to (3), an internal structure of the seat can be simplified.

(4) The vehicle seat according to any one of (1) to (3), where
the bracket has a guide portion (guide portion G) for guiding flow of air discharged from the blower device.

According to (4), provision of the guide portion makes it possible to control the air flow and to easily suppress noise during exhaust. In addition, the provision of the guide portion makes it possible to improve strength of the bracket.

(5) The vehicle seat according to (4), where
the bracket has a first opening (first opening 641B) connected to an intake port (intake port 632A) of the blower device and a second opening (second opening 641C) connected to an exhaust port (duct portion 61B) of the intake and exhaust unit, and
an outlet of the guide portion and the second opening face in the same direction.

According to (5), the internal structure of the seat can be simplified.

(6) The vehicle seat according to (4) or (5), where
an outlet of the guide portion faces downward of the vehicle seat.

According to (6), there is often more space under the seat, making it easier to create an escape route for air. This improves efficiency of using the space inside the seat, contributing to weight and size reduction.

(7) The vehicle seat according to any one of (4) to (6), where
the bracket has a first part (the part excluding the guide portion G) including a flow path forming portion (planar portion 641, U-shaped wall portion 642, and rear surface portion 643) having the air flow path in the flow path forming portion and facing the blower device, a second part (front wall portion 648) located forward of the vehicle seat relative to the first part, and a third part (left guide wall portion 646 and right guide wall portion 647) connecting the first part and the second part, and
the guide portion includes the second part and the third part.

According to (7), the second part forming the guide portion can receive a load from the front of the seat, and the strength of the bracket can be increased. Furthermore, when a seat front side surface of the blower device arranged in the flow passage forming portion and the second part of the bracket are substantially flush with each other, the second part and the front surface of the blower device can receive a load from the front of the seat over a wide surface, and when the bracket is supported by the seat frame, the load can be efficiently released to the seat frame.

(8) The vehicle seat according to (7), including:
a seat frame (seat frame 33), and
the bracket is supported by the seat frame in a state in which a space defined by the second part and the third part is closed by a part (upper frame 33U) of the seat frame.

According to (8), the seat frame can also be used to control the air flow, and the air flow can be controlled with high precision. By using the seat frame, the bracket structure can be simplified, made lighter, and its cost reduced.

What is claimed is:

1. A vehicle seat, comprising:
an intake and exhaust unit configured to perform intake and exhaust of air;
a blower device; and
a bracket supporting the blower device, wherein
the bracket includes an air flow path therein, the air flow path connecting the blower device and an exhaust port of the intake and exhaust unit.

2. The vehicle seat according to claim 1, wherein
the bracket is provided with a first opening connected to an intake port of the blower device and a second opening connected to the exhaust port of the intake and exhaust unit, and
the first opening and the second opening face in different directions with each other.

3. The vehicle seat according to claim 2, wherein
the first opening faces forward of the vehicle seat, and
the second opening faces downward of the vehicle seat.

4. The vehicle seat according to claim 1, wherein
the bracket includes a guide portion configured to guide flow of air discharged from the blower device.

5. The vehicle seat according to claim 4, wherein
the bracket is provided with a first opening connected to an intake port of the blower device and a second opening connected to an exhaust port of the intake and exhaust unit, and
an outlet of the guide portion and the second opening face in a same direction.

6. The vehicle seat according to claim 4, wherein
an outlet of the guide portion faces downward of the vehicle seat.

7. The vehicle seat according to claim 4, wherein
the bracket includes a first part, a second part, and third part, the first part including a flow path forming portion having the air flow path therein and facing the blower device, the second part being located forward of the vehicle seat relative to the first part, and the third part connecting the first part and the second part, and
the guide portion includes the second part and the third part.

8. The vehicle seat according to claim 7, further comprising:
a seat frame, and
the bracket is supported by the seat frame in a state in which a space defined by the second part and the third part is closed by a part of the seat frame.
